(19) United States
(12) Patent Application Publication
(10) Pub. No.: US 2015/0242578 A1
(43) Pub. Date: Aug. 27, 2015

(54) METHODS AND SYSTEMS FOR MITIGATING OR AVOIDING DELAYS IN INFUSION ROOM SEATING

(71) Applicant: Institute for Cancer Research d/b/a The Research Institute of Fox Chase Cancer Center, Philadelphia, PA (US)

(72) Inventor: Mark Andrew Siemon, Cheltenham, PA (US)

(21) Appl. No.: 14/707,076

(22) Filed: May 8, 2015

Related U.S. Application Data
(63) Continuation-in-part of application No. 13/802,988, filed on Mar. 14, 2013, now abandoned.
(60) Provisional application No. 61/737,457, filed on Dec. 14, 2012.

(51) Int. Cl. G06F 19/00

(52) U.S. Cl. CPC G06F 19/327

(57) ABSTRACT

A method and system for scheduling, tracking, recording, and monitoring of patients' usage of an infusion room, along with various tools to analyze the infusion room activity, to thereby improve usage of the infusion room, and improve patient satisfaction relating to their infusion room experience, is disclosed. The inventive methods and systems monitor, record, and analyze relevant infusion room chair status, patient status, and patient medical condition while in the infusion room, then determine if there will be anticipated or actual delays in a patient's scheduled infusion, and then implement corrective actions in order to mitigate or avoid such delays. The inventive methods and systems may be used in real-time.

### CROSS-REFERENCE TO RELATED APPLICATIONS

This application is a continuation-in-part of U.S. patent application Ser. No. 13/802,988, filed Mar. 14, 2013, which claims priority to U.S. Provisional Application No. 61/737,457, filed on Dec. 14, 2012. The contents of each application are incorporated by reference herein, in their entirety and for all purposes.

### FIELD

The invention relates generally to systems and methods for monitoring and managing usage of infusion room facilities, and more particularity, to systems and methods for scheduling, tracking, recording and monitoring the use of infusion room facilities by patients, and for making adjustments to infusion room scheduling, staffing, and use in order to mitigate or avoid anticipated or actual delays in infusion room patient seating.

### BACKGROUND

Various publications, including patents, published applications, technical articles and scholarly articles are cited throughout the specification. Each of these cited publications is incorporated by reference, in its entirety and for all purposes, in this document.

Infusion therapy involves the administering of medications to a patient intravenously through a needle or catheter. Such medication administration is often required when oral dosage or usage of the medication is not fully effective. Infusion rooms have been created and used in hospitals and other medical facilities for many years to allow patients the ability to have the intravenous medications administered in a controlled setting, and where the setting may be more aligned as an out-patient environment.

A typical infusion room is designed to centralize and process multiple patients at a given time to improve efficiencies of administering the medications, along with improving the efficient usage of the medical facility's personnel and infrastructure. However, as is true with most medical facilities, and the administering of medical assistance, such medical care is highly dependent upon the availability of medical personnel and availability and preparation of the necessary medications, and more importantly the varying needs and medical condition of the patient. Indeed, the scheduling and tracking of patients within an infusion room setting presents unique and challenging problems.

By way of example of certain of those problems, the flow of multiple patients through an infusion room is dependent upon several elements, including at least: (a) availability of specially trained medical personnel, including nurses; (b) availability of open infusion chairs for each patient; (c) availability and preparation of the particular and expensive medications; (d) timely operation of the supporting laboratory facility (relating to the patient's medications and blood work); and (e) availability of physician's to review the patient's records and medical condition. Medical personnel who work in infusion rooms, and patients (and family) who need to be at an infusion room fully understand that the flow and schedule of patients through the infusion room may be completely, and dynamically altered as a function of many variables, including patient blood test results, patient care needs that arise during the infusion treatment, and/or the evaluation of medical personnel relating to the patient's reaction and condition as a result of the infusion treatment. If the infusion room operations are inefficiently managed, there is a direct financial impact on the costs of operating such facilities.

In addition to identification of any system efficiencies, medical facilities and medical personnel at those facilities are always aware of, and seek to improve patient satisfaction relating to the patient's time in the infusion room. Any delays or apparent disorganization are important factors in a patient being dissatisfied with his or her exposure to the infusion room setting.

While it is often easy to see that an infusion room is crowded and certain patients are not moving through their treatments quickly, or that certain medication or medical personnel resources are not immediately available, the identification of the sources for any such delays or resources issues, is very difficult, especially given the dynamic nature of the infusion room operations. What is needed is a method and system to, in real-time, schedule, track, record, and monitor infusion room operations and activity and make appropriate adjustments to mitigate or avoid such delays.

### SUMMARY

A method for mitigating or avoiding delays in infusion room seating comprise determining whether there is an anticipated or actual delay in seating of patients scheduled for an infusion in the infusion room. Determining whether there is an anticipated or actual delay comprises determining one or more of whether there are delays in one or more physician offices that obtain patient samples to be sent to a laboratory that would cause one or more patients from said physician offices to arrive late for their scheduled infusion, whether, among patients already actively receiving an infusion in the infusion room, there is a higher than expected number of adverse reactions to the patients' respective infusion, whether there are delays in one or more collaborating laboratories in providing test results for one or more patients scheduled for infusion that necessitate a delay in the start of the infusion for the one or more patients scheduled for infusion, whether there are delays in one or more physician offices that interpret the test results toward determining whether the patient is in condition to receive an infusion, whether there are delays in or more collaborating pharmacies in filling prescriptions for the infusion medication for one or more patients scheduled for infusion, or whether there is an insufficient number of available infusion room chairs. If it is determined that there is an anticipated or actual delay in seating of patients, mitigating or avoiding the delay by one or more of rescheduling patients who have not yet begun an infusion in the infusion room, adjusting infusion room staffing, redistributing patient tests to a different laboratory than the one or more collaborating laboratories, or redistributing patient prescriptions to a different pharmacy than the one or more collaborating pharmacies.

In some aspects, if it is determined that there are delays in one or more physician offices that obtain patient samples to be sent to a laboratory that would cause one or more patients from said physician offices to arrive late for their scheduled infusion such that it is determined that there is an anticipated or actual delay in seating of patients, mitigating or avoiding the delay comprises rescheduling patients who have not yet begun an infusion in the infusion room, and said rescheduling may comprise identifying other patients that are scheduled for an infusion later in the day, and rescheduling these other patients for earlier in the day.

In some aspects, mitigating or avoiding the delay further comprises adjusting infusion room staffing. Adjusting infusion room staffing may comprise one or more of delaying the start of later shifts for infusion room medical personnel such that the infusion room may accommodate later patient stays, or scheduling additional infusion room medical personnel later in the day to accommodate a higher than anticipated volume of patients during later hours, or moving medical personnel from another area of the hospital to the infusion room such that there is medical personnel available to accommodate later patient starts or stays.

In some aspects, if it is determined that among patients already actively receiving an infusion in the infusion room, there is a higher than expected number of patients having an adverse reactions to their respective infusion such that it is determined that there is an anticipated or actual delay in seating of patients, mitigating or avoiding the delay may comprise rescheduling patients who have not yet begun an infusion in the infusion room, including rescheduling patients who have not yet arrived or begun their infusion for later in the day. Mitigating or avoiding the delay may further comprise adjusting infusion room staffing, including re-assigning supporting medical personnel from other areas to the infusion room in order to provide support for patients having an adverse reaction to their respective infusion.

In some aspects, if it is determined that there are delays in one or more collaborating laboratories in providing test results for one or more patients scheduled for infusion, mitigating or avoiding the delay may comprise redistributing patient tests to a different laboratory than the one or more collaborating laboratories. Mitigating or avoiding the delay may further comprise rescheduling patients who have not yet begun an infusion in the infusion room, including identifying patients not requiring lab test results as part of their infusion regimen, and then rescheduling those patients for earlier in the day.

In some aspects, if it is determined that there are delays in or more collaborating pharmacies in filling prescriptions for the infusion medication for one or more patients scheduled for infusion, mitigating or avoiding the delay may comprise redistributing patient prescriptions to a different pharmacy than the one or more collaborating pharmacies. Mitigating or avoiding the delay may further comprise rescheduling patients who have not yet begun an infusion in the infusion room, including identifying patients not requiring a prescription to be filled as part of the infusion regimen, and then rescheduling those patients for earlier in the day.

In some aspect, if it is determined that there is an insufficient number of available infusion room chairs, mitigating or avoiding the delay may comprises rescheduling patients who have not yet begun an infusion in the infusion room, including assigning said patients to a different chair when the different chair becomes available, including allowing said patients to leave and return when a chair becomes available. Mitigating or avoiding the delay may comprise adjusting infusion room staffing, including re-assigning or adding supporting specialized nurses to the infusion room in order to ensure an infusion room chair is available for patients ready to receive their infusion.

### BRIEF DESCRIPTION OF THE DRAWINGS

The invention is best understood from the following detailed description when read in conjunction with the accompanying drawing. It is emphasized that, according to common practice, the various features of the drawing are not to scale. On the contrary, the various features are arbitrarily expanded or reduced for clarity. Included in the drawing are the following figures:

FIG. 1 shows a block diagram of a computing system for monitoring infusion room operation and identifying conditions which have a negative impact on monitoring infusion room operation.

FIG. 2 shows a graphic layout of an input/output (I/O) system display.

FIG. 3 shows a graphic layout of a patient data entry layout system display.

FIG. 4 shows a graphic layout of a patient data entry layout system display a patient-specific system display.

FIG. 5 shows a graphic layout of a laboratory results system display.

### DETAILED DESCRIPTION

Various terms relating to aspects of the present disclosure are used throughout the specification and claims. Such terms are to be given their ordinary meaning in the art, unless otherwise indicated. Other specifically defined terms are to be construed in a manner consistent with the definition provided in this document.

As used throughout, the singular forms “a,” “an,” and “the” include plural referents unless expressly stated otherwise.

It has been observed that infusion room delays and backlogs can be anticipated or better discerned via real time tracking systems that collect and process data about infusion room use and attendant delays and backlogs, as caused by various patient, facilities, and peripheral factors. Such systems provide for improved efficiency of patient intake, scheduling of the patients for infusion room activity, tracking the status of each patient within the infusion room, including medical condition of the patient, recording all such activity and operations, and providing input and output means for input and monitoring of the infusion room operations. The systems and methods of using them predict and solve important problems with infusion room operations and, thereby, mitigate and avoid anticipated and actual delays.

Embodiments provide for methods and systems for improving the operation and management of one or more medical infusion rooms. The primary attributes of the inventive infusion room operations management methods and systems are to provide for efficient scheduling, tracking, recording, and monitoring of patients' usage of an infusion room, including usage of medical equipment and related facilities. The methods and systems include sophisticated computer processors, sensors, and related tools to allow analysis of the infusion room activity, including recorded activity. With use of such recorded usage data, infusion room managers are able to analyze how the medical facility is operated and being used, and thereby implement adjustment to usage of the infusion room, and thereby improve patient satisfaction relating to their infusion room experience.

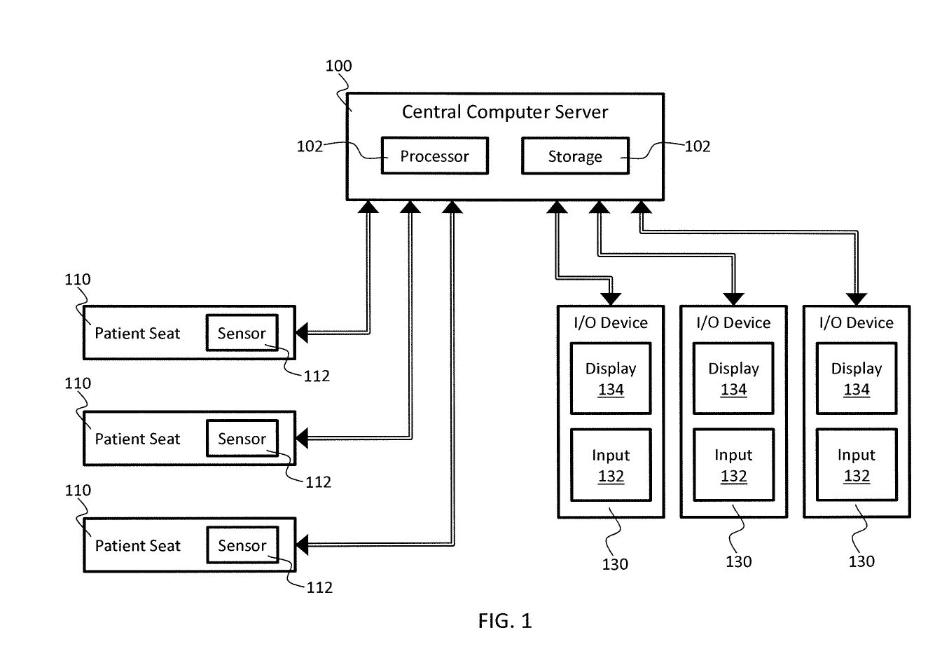

By way of a preferred embodiment and example, FIG. 1 illustrates a system architecture for the primary elements of the infusion room operations manager system 10. Such elements include a central computer server 100 that is in communication with a plurality of patient seats 110, and in communication with a plurality of input/output (“I/O”) systems 130. In certain embodiments the communications between the system elements can be wired, or with appropriate communication segregation, the communications between the computer servers 100, patient seats 110 and I/O systems 130 can be implemented wirelessly. The communication paths between the central computer server 100 and the patient seats 110 and I/O systems 130 should provide for two-way communication, such that information and data can be transmitted to and from the patient seats and 110 and I/O systems 130.

It will be understood that, although not shown in FIG. 1, the central computer server 100 may be connected to, or otherwise communicating with, other servers. In one embodiment, the central computer server 100 may be a distinct server physically located within the infusion room either independent from or connected to one or more other servers within a hospital or hospital complex. In other embodiments, the central computer server 100 may be a networked server located outside of the infusion room, or even a distributed network of servers, each of which may perform one or more of the functions of the central computer server 100, as described in more detail below.

Each of the plurality of patient seats 110 are equipped with one or more sensors 112 to track information relevant to the treatment process. In a preferred embodiment, the one or more sensors 112 include at least a system for determining whether or not the patient seat 110 is occupied. In one example, this system includes a button or similar device pushed by either the patient or an infusion room attendant (e.g., a nurse or a doctor) to indicate that the patient has entered or exited the patient seat 110. In another example, the patient seat 110 includes a sensor such as a weight sensor or a motion detector, which is capable of automatically detecting when a person is occupying the patient seat 110. The patient seats 110 may further be capable of tracking other information relevant to the treatment process, such as patient vitals (e.g., pulse blood pressure, body temperature, etc.) and/or infusion therapy status (e.g., amount of medication left to be infused, infusion rate, etc.). The patient seats 110 may further be capable of allowing the patient to indicate their needs or distress, for example by pressing a “call button” to indicate to infusion room personnel that they are in need of assistance. The patient seat 110 may be capable of storing the tracked information independently from the central computer server 100 (e.g., on a hard drive at the patient seat 110), or it may send the tracked information directly to the central computer server 100 for storage.

Each I/O system 130 includes any system capable of electronically receiving information from a user (i.e., inputs) and communicating other information (i.e. outputs) to the user. Exemplary I/O systems include desktop computers, laptop computers, tablets, etc. Each I/O system may also be able to track and send to the central computer server 100 the same or different information as the patient seats 110. For example, a nurse welcoming a patient into the infusion room may record the patient's arrival on a tablet computer.

The information tracked and recorded by the patient seats 110 (and, in some embodiments, the I/O systems 130) is continuously uploaded in real-time to the central computer server 100 and stored on central computer server 100. The central computer server 100 may store the tracked data on a local storage system 102, for example one or more hard drives, or may further upload the tracked data to networked storage located in the infusion room or elsewhere. The recorded information is maintained in a plurality of databases in a server log format so that all activity is time-stamped and readily traceable. If video recordings of the activity in the infusion room are also maintained, such video recordings can be linked with the central computer server 100 recorded data to show a visual of the infusion room activity.

Once the information is stored by the central computer server 100, it is easily accessible to any user of the I/O systems 130. Accordingly, infusion room personnel are able to quickly receive data and information from the central computer server 100 that may otherwise be inaccessible or difficult or inefficient to obtain. The infusion room personal may receive the data and information through a display 132 of the I/O system with a layout configured in any manner useful to the user. The display 132 is updated by the central computer server 100 on a real-time basis to provide current information and data to medical personnel. The information provided by the central computer server 100 to the display 132 comes from the patient seats 110 and optionally, one or more additional systems networked to the central computer server 100, including a scheduling system, a laboratory system, a patient check-in system, etc. In other embodiments, the additional systems may be maintained by the central computer server 100 itself. The central computer server 100 synthesizes the information from this disparate systems for display through the I/O systems 130 so that the synthesized information can be graphically displayed to a user.

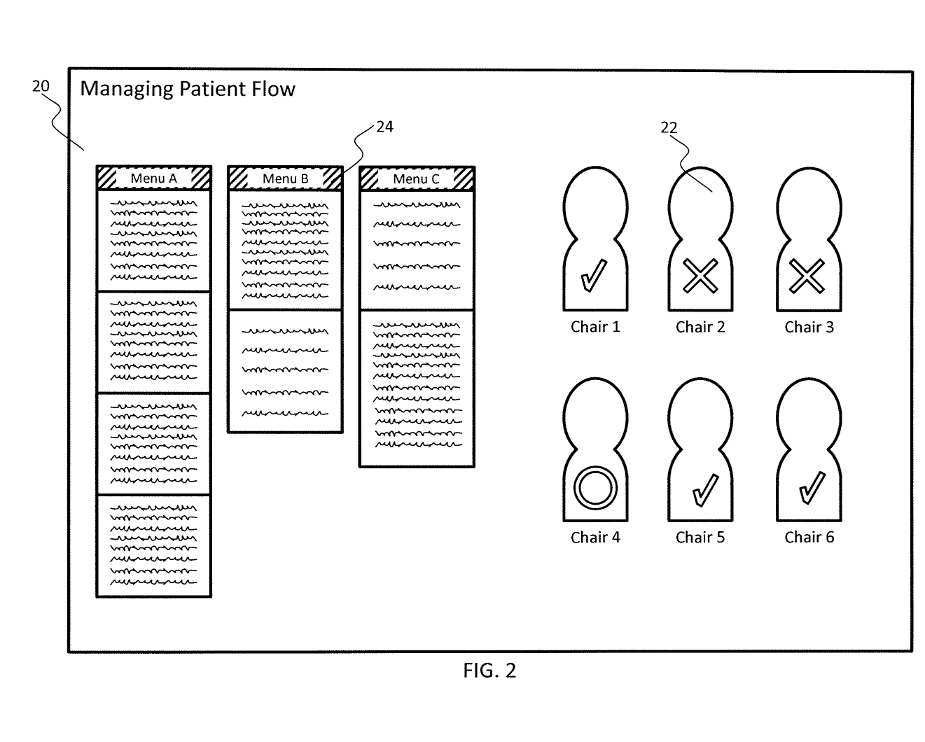

An exemplary layout 20 of an I/O system display 132 is shown in FIG. 2. The layout 20 shows data for managing patient flow through an infusion room. The layout 20 may show the status for each patient seat 110 in communication with the central computer server 100. For example, in FIG. 2, the layout 20 includes a seat icon 22 for each patient seat 110 with a symbol indicating the chair status (e.g., an “X” for a occupied seat, a check mark for an available seat, and a circle for a soon to be vacated seat). In other embodiments, the status indicator could be any suitable way of distinguishing between statuses, such as color coding (e.g., red for occupied, blue for available, orange for soon to be vacated). The seat icons 22 may also immediately communicate other information to the user of the I/O systems 130, for example by flashing or changing to a different color such as purple if the patient in that seat is in need of attention.

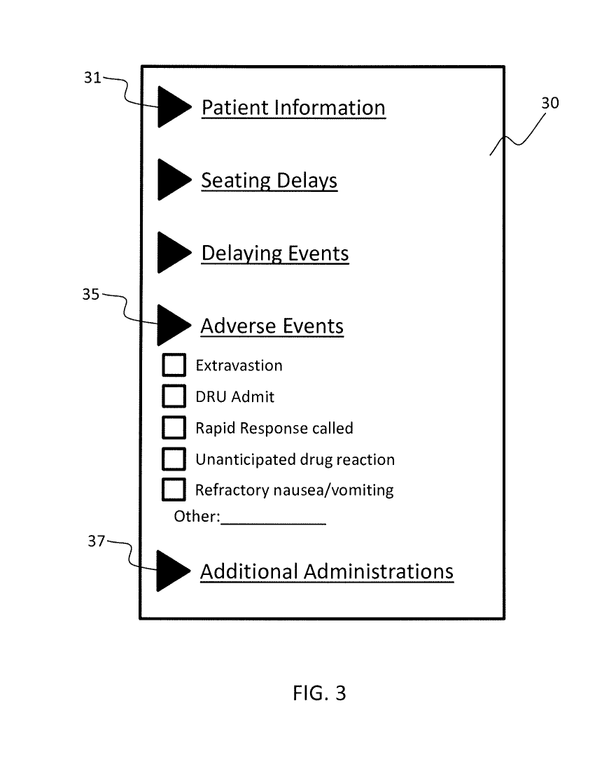

In some embodiments, the seat icons may be selectable by the user of the I/O system 130 to access a patient data entry layout 30, as shown in FIG. 3. From the patient data entry layout 30, the user of the I/O system 130 may retrieve or update information about the patient occupying a particular patient seat 110 through the “patient information” icon 31, or may enter information about “adverse events” by touching the “adverse events” icon 35. Similarly, other administration information may be retrieved or entered through the “additional administrations” icon 37. Accordingly, the I/O system 130 enables information to be transmitted back to the central computer server 100 rather than just flowing to the I/O system 130, allowing infusion room personnel to record and store patient information without being physically located at the central computer server 100. Instead, the infusion room personnel can collect patient information in a waiting room, at the patient seat 110, or outside of the infusion room entirely to accommodate the needs of a patient. All this information is then immediately accessible by the central computer server 100 such that the other I/O systems 130 can be updated in real-time.

In addition to the seat icons 22, the layout 20 also includes one or more menus 24. The menus 24 may be static (i.e., displaying the same information and unchangeable based on a user command) or dynamic and/or contextual (i.e., displaying different information in response to a user command or a change elsewhere in the system). The data shown in the menus 24 may include by way of preferred example, the patients' identification information to show who (a) has arrived at the infusion room, (b) is waiting for laboratory test results, (c) has received their laboratory test results, (d) is waiting to see or consult with their physician, (e) has returned from seeing or consulting with their physician, and (f) is ready to be seated at an infusion room seat.

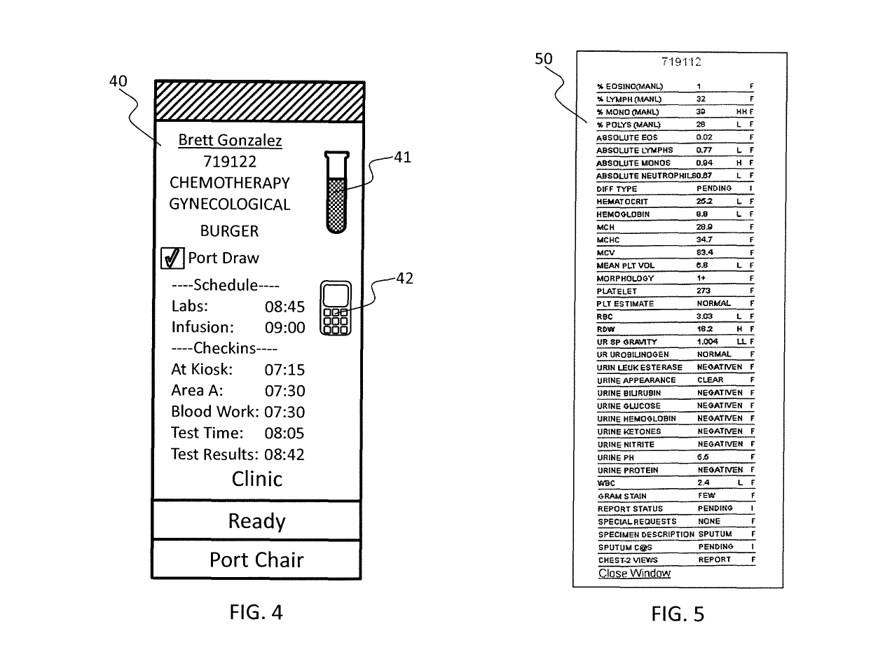

For example, Menu A may contain lists of the patients currently receiving treatment, the patients currently waiting for treatment, and the patients scheduled for treatment later in the day. A user may select a patient from the lists of Menu A and the layout 20 will pull data from the central computer server 100 and update Menu B to include detailed patient information for the patient selected from Menu A. In another embodiment, upon selecting the patient from the layout 20, the display may change to a second layout including just the detailed patient information. An exemplary patient specific layout 40 is depicted in FIG. 3. For example, the patient specific layout 40 includes the patient's name, a patient ID number, and the treatments the patient is schedule to receive. The patient specific layout 40 also includes the patient's schedule, as well as the actual times at which certain events occurred, such as the time the patient arrived at the kiosk, the time the patient arrived at Area A for blood work, the time blood work was initiated, the time for the patient's test, and the time for the patient's test results. The patient specific layout 40 also includes selectable icons such that the user of the I/O system 130 can quickly access other information, such as a test tube icon 41 to access the patient's laboratory results, for example by pulling up the results layout 50 depicted in FIG. 4, and a pager icon 42. In one embodiment, the pager icon 42 could allow a nurse or medical personnel to page the patient if he or she is not in the infusion room, or alternatively, the pager icon 42 could be implemented to allow the medical personnel talk to the patient at his or her infusion seat to check on the status of the patient. This ability to readily communicate with the patient has been shown to substantially increase the patient's level of satisfaction while in the infusion room. Knowing that someone is checking in and monitoring the patient's condition is what the patient expects and desires.

According the above the description, the central computer server 100 is capable of performing the steps of (a) monitoring the usage of each of the plurality of infusion room seats; (b) monitoring the status of each patient using each of the infusion room seats; (c) receiving input from the input/output devices entered by medical personnel; (d) storing and updating monitored patient status information in the plurality of databases; (e) storing input/output device display information in the databases; and (f) transmitting output data to said plurality of input/output devices to be viewed by medical personnel. By using the system above including a central computer server 100 managing and storing data sent to and from a plurality of patient seats 110 and a plurality of I/O systems 130, infusion room operations can be improved in a number of ways that are not possible with a manual system. For example, because the central computer server 100 monitors the occupancy of the patient seats 110 and is aware of when they will become available, the schedule for each chair can more easily be adjusted by the infusion room personnel to reduce downtime and inefficiency between patient appointments. Patients can also be informed of unavoidable delays and possibly rescheduled to later times to avoid waiting. Patients could also be given a pager and allowed to leave the infusion room area, and called back later when a chair becomes available, as described above.

Because the infusion room operations status, and patient information is being uploaded in real-time and stored, there is the capability of re-playing or displaying the infusion activity at a later time for off-line analysis and review. Such recordings of information includes system displays such as those shown in FIGS. 2-5, described in more detail above. Through review and analysis of the recorded data, it is possible to run simulations of infusion room activities, and thereby propose and test improvements to the system to ensure efficient use of the infusion room, and to improve patient satisfaction of their exposure to and time at the infusion room. Similarly, through analysis of the recorded data, many different reports analyzing the data can be generated. By way of example, such reports could include productivity reports for nurse practitioners; utilization reports for each infusion room chair (to note possible equipment problems); and different average times for obtaining necessary data, including laboratory test results, and availability of medical personnel, including physicians.

By using the simulations, it is possible to identify conditions that frequently lead to delays hours later. While infusion room personnel may be able to observe a crowded waiting area and understand that there is an issue, it frequently too late by that point to respond to the cause of the problem and alleviate the delay. Instead, the system disclosed herein allows for the identification of problems that will lead to delays while they can still be addressed.

In another example, the central computer server 100 may receive information from the patient seats 110 indicating that there are an abnormal of adverse reactions that will require those patients to remain in the infusion room for longer than expected, or require greater attention from infusion room personnel. The central computer server 100 will communicate this occurrence to infusion room personnel through the I/O systems 130, at which point the infusion room personnel can respond by, for example, rescheduling later patients to reduce their wait time or reassigning personnel from other areas to provide additional support to the infusion room patients.

In another example, the central computer server 100 may receive information that there is an unusual number of patients waiting for lab results before beginning treatments and communicate this occurrence to infusion room personnel, who can redistribute lab appointments to available locations, or reschedule patients that are present and do not require lab tests to earlier to avoid idle patient seats 110.

In another example, the central computer server 100 may also receive information from a referring physician's office that the referring physician is running behind schedule that that patients coming from that office will be late for their infusion room appointments and communicate this occurrence to infusion room personnel, who can adjust staffing by delaying the start of later shifts to accommodate later patient stays or arrange for additional staff later in the day to address the larger than anticipated volume at that time. The infusion room personnel could further identify patients scheduled for later appointments that are present and ready for treatment and reschedule them for earlier to reduce the anticipated later volume.

As illustrated by the above examples, embodiments also include methods of improving infusion room efficiency by observing identifying a condition that will cause negative impacts on the infusion room schedule and alerting infusion room personnel to the existence of the condition, and taking appropriate corrective action to prevent the condition from causing the negative impacts. Examples of such corrective action include rescheduling patients prior to their arrival at the infusion room to alleviate periods where there are more patients than available patient seats and reallocating personnel to the infusion room to serve unexpected patient needs.

Generally speaking, a patient who will receive a chemotherapy infusion will begin the process with lab tests (e.g., appropriate blood work) to determine whether the patient is in condition to receive the chemotherapy infusion, although some patients do not require lab tests prior to receiving their respective infusion. The patient's tests are processed by a lab, and the test results are provided to the patient's physician, who then interprets the results and determines whether the patient is in condition to receive the infusion. If the patient is in condition to receive the infusion, the physician prescribes the appropriate drugs to be prepared (that which is to be infused into the patient), and the prescription is filled by a pharmacy. Once the prescribed infusion is prepared by the pharmacy, it is sent to the infusion room. The patient may then be seated in the infusion room where the drugs are administered to the patient.

This process for preparing a patient for infusion presents a number of opportunities for delays, which can have a ripple effect on the infusion room on the whole. This ripple effect can be further compounded by multiple delays (at various stages of the process) and/or by delays for multiple patients scheduled for an infusion on a given day. For example, delays may occur if the patient arrives late to the test appointment, if the physician office that is to obtain the patient samples (the tests) is delayed, if the laboratory processing the patient samples is backlogged or delayed (or if there are delays in delivering the patient samples to the lab), if the physician's office is delayed in receiving or interpreting the test results from the lab, if the physician's office delays calling in the appropriate prescription, and/or if the pharmacy is backlogged or delayed in terms of filling the infusion prescription for the patient. Additional delays may occur in the infusion room itself, for example, because an unexpected number of patients already receiving an infusion have had an adverse reaction to their infusion, and/or because of insufficient or improper staffing of the infusion room (e.g., insufficient number of specialized nurses). In accordance with the invention, such delays (and their sources) may be anticipated, identified, tracked, and/or logged, and then mitigated or avoided.

In some detailed aspects, a method comprises determining an anticipated or actual delay in a patient's scheduled infusion, for example, resulting from delays attendant to infusion room delays or backlogs. The determination of delays in a patient's infusion schedule may be, for example, by coordinated use of the systems and components described or exemplified herein. The methods may further comprise determining the source of the anticipated or actual delay in the patient's scheduled infusion. Upon determination of such an anticipated or actual delay, the methods comprise implementing a corrective response to mitigate or avoid the anticipated or actual delay. The methods may be carried out to mitigate or avoid anticipated or actual delays in the scheduled infusion for a plurality of patients. The methods may be carried out in real time. The methods are suitable for high throughput infusion room delay tracking and remediation.

Determining an anticipated or actual delay may comprise one or more of determining whether there are delays in one or more medical offices that would cause one or more patients to arrive late for their scheduled infusion, whether, among patients already actively receiving an infusion in the infusion room, there is a higher than average or higher than expected number of adverse reactions to the respective infusion, whether there are delays in one or more collaborating laboratories in providing test results and/or there are delays in the physician's office in interpreting the test results, which would delay filling of prescriptions for the infusion medication or otherwise necessitate a delay in the start of the infusion, whether there are delays in or more collaborating pharmacies in filling prescriptions for the infusion medication, or whether there otherwise is an insufficient number of available infusion room chairs, for example, because of overbooking, insufficient available specialized nurses (in the infusion room setting, nurses generally specialize in patients with particular cancers), malfunctioning infusion equipment, or other situation that reduces the number of available infusion room chairs. Any of these determinations, considered alone or in any combination, may reveal the source of the anticipated or actual delay in a patient's scheduled infusion.

Once it has been determined that a delay is anticipated, or is imminent, or is occurring, the methods include implementing a corrective action to mitigate or avoid the delay. The particular corrective action may depend, for example, on the particular source of the anticipated or actual delay. In general, corrective action may include one or more of rescheduling one or more patients who are expected to be impacted by the delay (e.g., those patients whose infusion is likely to be or will be delayed by the infusion room delay or backlog), enhancing infusion room staffing (e.g., providing additional nurses that specialize in the cancers being treated in the infusion room that day), or redistributing laboratory tests or prescriptions to other laboratories or pharmacies that have capacity such that the tests may be completed and/or the prescriptions filled in a more timely manner.

For example, if it is determined that there are delays in one or more medical offices that would cause one or more patients to arrive late for their schedule infusion, delay mitigation or avoidance may comprise delaying the start of later shifts in infusion room medical personnel such that the infusion room may accommodate later patient stays. Delay mitigation or avoidance may comprise scheduling additional infusion room medical personnel later in the day to accommodate a higher than anticipated volume of patients during later hours. Delay mitigation or avoidance may comprise identifying patients that are already present but scheduled for later in the day, and then rescheduling those patients for earlier in the day in order to reduce the anticipated volume of patients during later hours. Delay mitigation or avoidance may comprise any combination of such patient and/or medical personnel scheduling and/or staffing adjustments.

If it is determined that among patients already actively receiving an infusion in the infusion room, there is a higher than average or higher than expected number of adverse reactions to the respective infusion, delay mitigation or avoidance may comprise rescheduling patients who have not yet arrived or begun their infusion for later in the day in order to reduce their wait time. Delay mitigation or avoidance may comprise re-assigning supporting medical personnel from other areas to the infusion room in order to provide support for patients having an adverse reaction. Delay mitigation or avoidance may comprise any combination of such patient and/or medical personnel scheduling and/or staffing adjustments.

If it has been determined that there are delays in one or more collaborating laboratories in providing patient test results, delay mitigation or avoidance may comprise redistributing patient samples or test data to another laboratory having assessment capacity in order to process patient samples and test data at a faster rate. Delay mitigation or avoidance may additionally or alternatively comprise identifying patients not requiring lab test results as part of the infusion regimen, and then rescheduling those patients for earlier in the day in order to reduce the anticipated volume of patients during later hours.

If it has been determined that there are delays in or more collaborating pharmacies in filling prescriptions for the infusion medication, delay mitigation or avoidance may comprise redistributing patient prescriptions to another pharmacy having prescription-filling capacity in order to provide patient medications at a faster rate. Delay mitigation or avoidance may additionally or alternatively comprise identifying patients not requiring particular prescriptions to be fulfilled as part of the infusion regimen, and then rescheduling those patients for earlier in the day in order to reduce the anticipated volume of patients during later hours.

If it has been determined that there are delays due to an insufficient number of available infusion room chairs, delay mitigation or avoidance may comprise identification of chairs that will be available soon (e.g., by color coding as described above), and rescheduling patients to chairs as they become available. Delay mitigation or avoidance may additionally or alternatively comprise informing impacted patients of the anticipated delay, and allowing patients to leave and return upon a page as soon as a chair becomes available. To the extent the delay is due to malfunctioning equipment, delay mitigation or avoidance may include repairing or replacing the malfunctioning equipment. If the delay is due to an insufficient number of specialized nurses (e.g., nurses that specialize in the particular types of cancers being treated in the infusion room on the day of the delay), delay mitigation or avoidance may additionally or alternatively comprise re-assigning appropriate specialized nurses from other areas to the infusion room in order to provide specialized support for infusion room patients.

While certain exemplary embodiments have been disclosed and described, there are other method variations and system configurations for infusion room scheduling, tracking, and monitoring that are equally possible using the method steps and system elements and architecture as disclosed herein. Such equivalent configurations are deemed fully within the scope of the inventive methods and systems for infusion room operations management. Those having ordinary skill in the art and access to the teachings provided herein will recognize additional modifications, applications, embodiments and substitution of equivalents all of which are within the scope of the invention. Accordingly, the invention is not to be considered as limited by the foregoing description.

What is claimed:

1. A method for mitigating or avoiding delays in infusion room seating, the method comprising:
determining whether there is an anticipated or actual delay in seating of patients scheduled for an infusion in the infusion room, comprising determining one or more of (a) whether there are delays in one or more physician offices in obtaining patient test samples, (b) whether, among patients already actively receiving an infusion in the infusion room, there is a higher than expected number of adverse reactions to the patients' respective infusion, (c) whether there are delays in one or more collaborating laboratories in providing test results for one or more patients scheduled for infusion, (d) whether there are delays in one or more physician offices in interpreting the test results, (e) whether there are delays in or more collaborating pharmacies in filling prescriptions for the infusion medication for one or more patients scheduled for infusion, or (f) whether there is an insufficient number of available infusion room chairs;
if it is determined that there is an anticipated or actual delay in seating of patients, mitigating or avoiding the delay by one or more of (i) rescheduling patients who have not yet begun an infusion in the infusion room, (ii) adjusting infusion room staffing, (iii) redistributing patient tests to a different laboratory than the one or more collaborating laboratories, or (iv) redistributing patient prescriptions to a different pharmacy than the one or more collaborating pharmacies.

2. The method of claim 1, wherein it is determined that there are delays in one or more physician offices in obtaining patient test samples such that it is determined that there is an anticipated or actual delay in seating of patients, and mitigating or avoiding the delay comprises rescheduling patients who have not yet begun an infusion in the infusion room, wherein the rescheduling comprises identifying other patients that are scheduled for an infusion later in the day, and then rescheduling the other patients for earlier in the day.

3. The method of claim 2, wherein mitigating or avoiding the delay further comprises adjusting infusion room staffing, wherein adjusting infusion room staffing comprises one or more of delaying the start of later shifts in infusion room medical personnel such that the infusion room may accommodate later patient stays, or scheduling additional infusion room medical personnel later in the day to accommodate a higher than anticipated volume of patients during later hours.

4. The method of claim 1, wherein it is determined that among patients already actively receiving an infusion in the infusion room, there is a higher than expected number of patients having an adverse reactions to their respective infusion such that it is determined that there is an anticipated or actual delay in seating of patients, and mitigating or avoiding the delay comprises rescheduling patients who have not yet begun an infusion in the infusion room, wherein the rescheduling comprises rescheduling patients who have not yet arrived or begun their infusion for later in the day.

5. The method of claim 4, wherein mitigating or avoiding the delay further comprises adjusting infusion room staffing, wherein adjusting infusion room staffing comprises re-assigning supporting medical personnel from other areas to the infusion room in order to provide support for patients having an adverse reaction to their respective infusion.

6. The method of claim 1, wherein it is determined that there are delays in one or more collaborating laboratories in providing test results for one or more patients scheduled for infusion such that it is determined that there is an anticipated or actual delay in seating of patients, and mitigating or avoiding the delay comprises redistributing patient tests to a different laboratory than the one or more collaborating laboratories.

7. The method of claim 6, wherein mitigating or avoiding the delay further comprises rescheduling patients who have not yet begun an infusion in the infusion room, wherein the rescheduling comprises identifying patients not requiring lab test results as part of their infusion regimen, and then rescheduling those patients for earlier in the day.

8. The method of claim 1, wherein it is determined that there are delays in or more collaborating pharmacies in filling prescriptions for the infusion medication for one or more patients scheduled for infusion, and mitigating or avoiding the delay comprises redistributing patient prescriptions to a different pharmacy than the one or more collaborating pharmacies.

9. The method of claim 8, wherein mitigating or avoiding the delay further comprises rescheduling patients who have not yet begun an infusion in the infusion room, wherein the rescheduling comprises identifying patients not requiring a prescription to be filled as part of the infusion regimen, and then rescheduling those patients for earlier in the day.

10. The method of claim 1, wherein it is determined that there is an insufficient number of available infusion room chairs, and mitigating or avoiding the delay comprises adjusting infusion room staffing to make infusion room chairs available, wherein adjusting infusion room staffing comprises re-assigning or adding specialized nurses to the infusion room.

10. The method of claim 1, wherein it is determined that there is an insufficient number of available infusion room chairs, and mitigating or avoiding the delay comprises rescheduling patients who have not yet begun an infusion in the infusion room, wherein the rescheduling comprises allowing said patients to leave and return when a chair becomes available.

11. The method of claim 10, further comprising notifying said patients when the chair becomes available.

12. A system for scheduling, tracking, recording, and monitoring of activity and patients' usage of an infusion room including a plurality of patient seats, the system comprising:
a central computer server;
a plurality of sensors monitoring the status of the patient seats in two-way communication with the central computer server; and
a plurality of input/output devices in two-way communication with the central computer server for use by infusion room personnel,
wherein the central computer server is adapted to
(i) record and store information received from the plurality of sensors and the plurality of input/output devices,
(ii) identify in real-time a condition that will cause negative impacts on the infusion room schedule based on the stored information, and
(iii) alert infusion room personnel to the existence of the identified condition by sending information related to the identified condition to a input/output device, whereby the infusion room personnel are able action based on the identified condition to alleviate the negative impacts caused by the condition before a problem occurs.

13. The system of claim 12, wherein the central computer server is further adapted to record and store information from an external computer system networked to the central computer server and further identify in real time the condition that will cause negative impacts on the infusion room schedule based information received from the external computer system.

14. The system of claim 12, wherein the action taken to alleviate the negative impacts caused by the condition includes adjusting patient scheduling.

15. The system of claim 12, wherein the action taken to alleviate the negative impacts caused by the condition includes adjusting infusion room staffing.

16. The system of claim 12, wherein the central computer server is further adapted to replay the stored information on demand and to simulate infusion room operations based on the stored information to identify the condition that will cause negative impacts on the infusion room schedule.
